(19) United States
(12) Patent Application Publication
(10) Pub. No.: US 2026/0310201 A1
(43) Pub. Date: Oct. 8, 2026

(54) METHOD AND DEVICE FOR PROCESSING RADAR DATA OF A RADAR SENSOR IN A VEHICLE

(71) Applicant: Robert Bosch GmbH, Stuttgart (DE)

(72) Inventors: Lewis Luyken, Cockatoo Victoria (AU); Max Henty-Scown, Clayton (AU)

(21) Appl. No.: 19/630,651

(22) Filed: Mar. 27, 2026

(30) Foreign Application Priority Data
Apr. 4, 2025 (DE) 10 2025 113 217.8

(51) Int. Cl. G05D 1/242; G01S 13/931; G05D 1/246; G05D 111/30

(52) U.S. Cl. CPC G05D 1/242; G01S 13/931; G05D 1/246; G05D 2111/30

(57) ABSTRACT

A method and a device for processing data of a radar sensor in a vehicle using a high-resolution map. The method includes: reading in the high-resolution map, in which at least one radar backscatter profile is stored at at least one map position which indicates which data the radar sensor of the vehicle would be expected to receive when the vehicle passes the associated map position; determining a current position of the vehicle; receiving data from the radar sensor; comparing the received data of the radar sensor with at least one stored radar backscatter profile at at least one map position in an environment of the current position of the vehicle; labeling the radar data according to the result of the comparison; and providing the marked radar data.

### CROSS REFERENCE

The present application claims the benefit under 35 U.S.C. § 119 of Germany Patent Application No. DE 10 2025 113 217.8 filed on Apr. 4, 2025, which is expressly incorporated herein by reference in its entirety.

### FIELD

The present disclosure relates to a method for processing radar data of a radar sensor in a vehicle along with a device for carrying out the method.

### BACKGROUND INFORMATION

Germany Patent Application No. DE 10 2013 210 928 A1 describes a method for distinguishing between real obstacles and false obstacles in a driver assistance system for motor vehicles. This system uses a tracking system and a radar sensor to detect and classify objects. Through comparison with a database of known false obstacles, misinterpretations of radar echoes, such as those caused by manhole covers, are intended to be avoided. The described method concentrates on the avoidance of false positive results, but does not mention an explicit comparison between actually received and expected radar radiation profiles, from which in particular useful information regarding the operating state or for calibration of the radar sensor can be obtained.

### SUMMARY

Radar sensors in vehicles provide information regarding the environment of the vehicle, which are used for supporting driver assistance systems. However, the interpretation of the radar data can be impaired by interference signals and changing environmental conditions. Existing methods for filtering and interpreting radar data often do not achieve the desired robustness and reliability, in particular in complex traffic situations.

However, the negative influence of interference states such as a blockage or an incorrect orientation of the radar sensor on the interpretation of the radar data can be significantly reduced through the additional use of digital maps, in particular high-resolution maps (HD maps).

The present disclosure provided a method for processing data of a radar sensor in a vehicle using a high-resolution map. According to an example embodiment, the method comprises a step of reading in the high-resolution map, in which at least one radar backscatter profile is stored at at least one map position, which indicates which data the radar sensor of the vehicle would be expected to receive when the vehicle passes the associated map position, and a step of determining a current position of the vehicle. The method further comprises a step of receiving data of the radar sensor, a step of comparing the received data of the radar sensor with at least one stored radar backscatter profile at at least one map position in an environment of the current position of the vehicle, a step of labeling the radar data according to the result of the comparison and a step of providing the labeled radar data.

A high-resolution map is to be understood, for example, as a digital map that is present in the form of (map) data values on a storage medium. This map is, for example, designed so that it comprises a plurality of map layers. A first map layer provides, for example, geographic information in the form of satellite images or orthorectified aerial images, while a second map layer contains detailed radar data profiles at predefined map positions.

According to an example embodiment, a further map layer can additionally provide information regarding traffic flow, road courses, along with terrain-specific features, in order to enable precise localization and classification of the radar data.

Radar data profiles are to be understood as data that are detected with radar sensors or can be used for interpretation of radar sensor data. In particular, the radar data profiles comprise radar backscatter profiles that indicate which radar radiation a radar sensor of a vehicle would detect when the vehicle passes the associated map position.

In an example embodiment, the radar backscatter profiles contain angle-dependent information regarding the expected radar backscatter at a map position. Here, the radar backscatter that a vehicle would detect when passing a map position under different angles and on different trajectories can advantageously be characterized.

In a further example embodiment, different radar backscatter profiles for different radar sensor types are stored in the high-resolution map. Here, possible differences in data acquisition and data processing of different sensor types can advantageously be represented and compensated. Different sensor types are intended to mean both radar sensors of identical construction but different manufacturers along with radar sensors of different construction, such as pulse or FMCW (frequency modulated continuous wave) radar sensors.

Through the comparison of the received data of the radar sensor with the at least one stored radar backscatter profile, an increased confidence in the validity of the received radar data can advantageously be obtained. This applies in particular to situations in which the distribution of the received radar data deviates from a statistically expected basic distribution. If, for example, no or only weak backscatter signals are received from the radar sensor of a vehicle over an extended period of time and at the same time according to the radar backscatter profiles only no or weak backscatter signals are to be expected, the use of the radar backscatter profiles contributes to an increased confidence in the validity of the received radar data.

In an example embodiment, the method is additionally or alternatively designed so that the high-resolution map in combination with the labeled radar data is used for supporting automated vehicle operation. Here, the determination of the vehicle position is performed e.g. with the aid of GPS or further sensor data, while the comparison of the received radar data with the stored radar backscatter profiles serves to identify potential obstacles or deviating environmental conditions. The automated operation of the vehicle comprises in this connection, e.g., determining an optimal trajectory, adapting the vehicle speed along with performing safety-relevant driving functions, as are used in particular within the framework of partially to fully automated operating modes (corresponding to SAE levels 1 to 5 according to the standard SAE J3016).

Advantageous further developments and improvements of the method disclosed herein are made possible by the measures disclosed herein.

In a preferred configuration, a blockage of the radar sensor is determined if the received data of the radar sensor deviate from the at least one stored radar backscatter profile in such a way that objects that, according to the radar backscatter profile, should be detectable are not detectable based on the received data of the radar sensor.

A blockage of the radar sensor is to be understood, for example, as a complete or partial covering of the transmitting and/or receiving unit of the radar sensor by one or more objects. If a vehicle detects constant radar signals when passing a map position, even though according to the radar backscatter profiles stored for this map position varying radar signals would have been expected, it can advantageously be concluded with a higher probability that a blockage of the radar sensor is present than would be possible without inclusion of the radar backscatter profiles.

In a further preferred configuration, when comparing the received data of the radar sensor with the at least one stored radar backscatter profile, environmental conditions in the environment of the vehicle such as the weather are taken into consideration.

The environmental conditions in the environment of the vehicle can influence the backscatter of radar signals. For example, water droplets or ice crystals during rain or snow can scatter or attenuate the radar waves, which leads to a change of the signal.

In one possible example embodiment, a plurality of radar backscatter profiles for different weather conditions are stored in the digital map. When the vehicle passes a map position, the current weather conditions at this map position are read in with the aid of a weather service (e.g., HERE Weather API, OpenWeatherMap API). Subsequently, the radar backscatter profile for that weather condition is selected and used for the comparison that corresponds most strongly to the read-in current weather conditions. The strength of the correspondence can be determined, for example, through a comparison of quantitative parameters such as temperature, humidity or precipitation amount per unit of time.

In a further possible example embodiment, according to the weather conditions, a confidence value is determined which is incorporated into the comparison between the stored radar backscatter profile and the radar data received by a vehicle. The confidence value is, for example, higher under weather conditions under which no changes of the radar signals due to the weather conditions are to be expected and lower under weather conditions under which a change of the radar signals due to the weather conditions is to be expected. In the case of a high confidence value, a deviation between a stored radar backscatter profile and the radar data received by a vehicle is attributable with a higher probability to a malfunction of the radar sensor than in the case of a low confidence value.

In a further preferred configuration, the high-resolution map additionally comprises positions of static objects. Objects are detected with the aid of the received data of the radar sensor and the positions of the detected objects are compared with the positions of the static objects on the high-resolution map.

Detected objects which do not correspond to static objects on the map are classified as dynamic objects.

Static objects are to be understood as objects, the position of and associated radar backscatter profile of which do not change depending on time. These comprise, for example, buildings, streetlights, traffic signs or guardrails at the roadside.

Dynamic objects are to be understood as objects, the position and associated radar backscatter profile of which change depending on time. These comprise, for example, traffic objects such as trucks or rail vehicles or movable road objects such as lift bridges or railroad crossings.

Dynamic objects can be detected as seemingly static objects if they are regularly positioned at the same map positions. For example, a rail vehicle can regularly come to a stop at a railroad signal or crossing at the same location on the map. If no distinction is made between static and dynamic objects, there is a risk that in the absence of the dynamic object an incorrect conclusion is drawn regarding a malfunction of the radar sensor, since the received radar signals do not correspond to the stored radar backscatter profiles. The explicit labeling of dynamic objects therefore advantageously reduces the probability of such an incorrect determination.

In a further preferred configuration, an orientation of the radar sensor of the vehicle is determined, wherein dynamic objects are not taken into consideration during the orientation.

A radar sensor of a vehicle can be continuously recalibrated during driving operation using the received radar data. One aspect of this recalibration is a determination of the orientation of the radar sensor relative to the vehicle based on stationary and moving objects in the environment of a vehicle. For this determination, in particular a relative velocity between the vehicle and an object in the environment of the vehicle determined with the aid of the radar data can be used. However, if an object, such as a rail vehicle, begins to move during the determination of the orientation of the radar sensor, the changing relative movement can lead to an incorrect determination of the orientation of the radar sensor.

Through not taking dynamic objects into consideration during the determination of the orientation of the radar sensor, such an incorrect determination can advantageously be avoided.

In a further preferred configuration, the radar backscatter profiles stored in the high-resolution map are generated by aggregating radar data from a plurality of vehicles.

Advantageously, in this configuration the radar backscatter profiles can be generated particularly efficiently, since individual vehicles can contribute radar data during arbitrary journeys along positions on the high-resolution map, without having to specifically approach such positions solely for radar data generation. In addition, through a plurality of vehicles that pass certain map positions at different points in time, radar data can be detected at different points in time, which advantageously increases the temporal heterogeneity of the detected radar data.

In a further preferred configuration, the method is implemented in a driver assistance system that comprises an adaptive cruise control system and/or an automatic emergency braking system.

Radar sensors contribute data for adaptive cruise control systems and automatic emergency braking systems. In such systems, it is particularly important to correctly detect objects in the current and future driving area of a vehicle, since an incorrect detection of an object can lead both to an erroneously performed braking action and to an erroneously omitted braking action. The presented method simplifies the correct detection of objects by means of radar systems and therefore advantageously contributes to an increase of the functional safety of adaptive cruise control systems and automatic emergency braking systems.

A device, in particular a computing unit, is provided which is configured to execute all steps of the method according to one or more of the methods of the present disclosure.

In one example embodiment, the device in particular comprises a computing unit (processor, working memory, storage medium) and suitable software (computer program) in order to execute the method according to one of the method disclosed herein. In one embodiment, the device comprises a transmitting and/or receiving unit which is designed to exchange data values—in particular with an external server or a cloud. In another embodiment, the device is designed as a server or a cloud (i.e., a network of servers or computing units).

Furthermore, a computer program is provided, comprising commands that, when the computer program is executed by a computer, cause the computer to execute a method according to one of the methods disclosed herein.

Furthermore, a machine-readable storage medium on which the computer program is stored is provided.

### BRIEF DESCRIPTION OF THE DRAWINGS

Exemplary embodiments of the present disclosure are explained in more detail below with reference to the figures.

FIG. 1 shows an exemplary embodiment of the method in the form of a flowchart.

FIG. 2 shows an exemplary embodiment of the method using the example of static and dynamic objects in a traffic situation.

### DETAILED DESCRIPTION OF EXAMPLE EMBODIMENTS

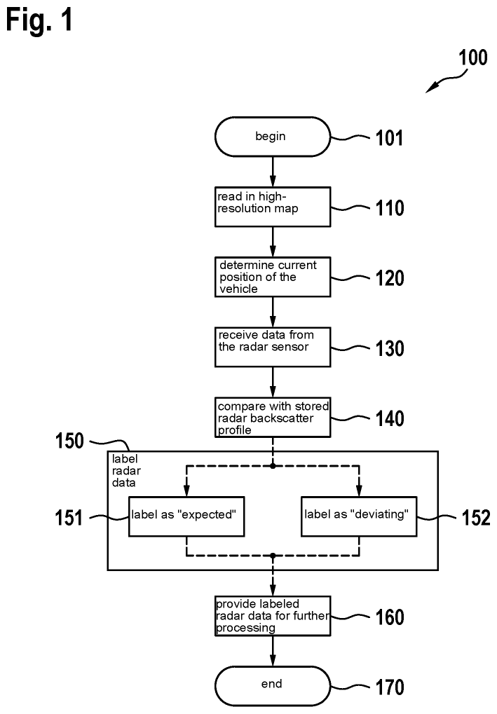

FIG. 1 shows an exemplary embodiment of a method 100 according to the present disclosure in the form of a flow chart.

In step 101, the method 100 begins.

In step 110, a high-resolution map is read in, in which at least one radar backscatter profile is stored at at least one map position, which indicates which data the radar sensor of the vehicle would be expected to receive when the vehicle passes the associated map position.

In step 120, a current position of the vehicle is determined.

In step 130, data from the radar sensor is received.

In step 140, the received data of the radar sensor are compared with at least one stored radar backscatter profile at at least one map position in an environment of the current position of the vehicle.

In step 150, the radar data are labeled according to the result of the comparison.

In step 151, the radar data are, for example, labeled as “expected” if the radar data correspond to the at least one stored radar backscatter profile using a predefined comparison measure, wherein the comparison measure is defined, for example, so that in particular the intensity and spatial distribution of the radar backscatter are taken into consideration.

In step 152, the radar data are, for example, labeled as “deviating” if the radar data do not correspond to the at least one stored radar backscatter profile using a predefined comparison measure.

In step 160, the labeled radar data are provided for further processing steps.

In step 170, the method 100 ends.

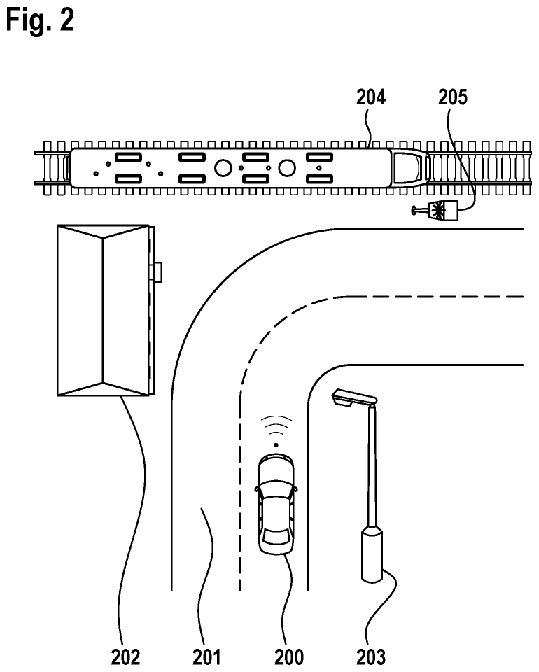

FIG. 2 shows an exemplary embodiment of the method using the example of static and dynamic objects in a traffic situation.

A vehicle 200 with at least one radar sensor for detection of objects in the surroundings of the vehicle moves along a road 201. In the surroundings of the vehicle 200, there are both static objects such as a house 202 or a streetlight 203 along with dynamic objects such as a train 204.

The train 204 temporarily becomes a static object if it comes to a stop, e.g. before a light signal 205. Static objects can be used for automated calibration and orientation of the radar sensor of the vehicle 200. If, for example, the train 204 is used as a static object for calibration and orientation of the radar sensor of the vehicle, but resumes movement during this process, this can lead to the incorrect calibration and orientation of the radar sensor. Through the inclusion of the high-resolution map within the framework of the presented method, such incorrect calibrations and orientations of the radar sensor can advantageously be avoided.

What is claimed is:

1. A method for processing data of a radar sensor in a vehicle using a high-resolution map, the method comprising the following steps:
reading in the high-resolution map, in which backscatter profiles are stored at associated map positions, each of the backscatter profiles indicating which data the radar sensor of the vehicle would be expected to receive when the vehicle passes the associated map position;
determining a current position of the vehicle;
receiving data from the radar sensor;
comparing the received data of the radar sensor with at least one of the stored radar backscatter profiles at a map position in an environment of a current position of the vehicle;
labeling the radar data according to a result of the comparison; and
providing the labeled radar data.

2. The method according to claim 1, wherein a blockage of the radar sensor is determined when the received data of the radar sensor deviate from the at least one stored radar backscatter profile in such a way that objects that, using the at least one radar backscatter profile, should be detectable are not detectable based on the received data of the radar sensor.

3. The method according to claim 2, wherein when comparing the received data of the radar sensor with the at least one stored radar backscatter profile, environmental conditions in the environment of the vehicle are taken into consideration.

4. The method according to claim 3, wherein the environmental conditions include weather.

5. The method according to claim 1, wherein the high-resolution map further includes positions of static objects, and wherein objects are detected using the received data of the radar sensor and positions of the detected objects are compared with the positions of the static objects in the high-resolution map, wherein detected objects that do not correspond to static objects on the map are classified as dynamic objects.

6. The method according to claim 5, wherein an orientation of the radar sensor of the vehicle is determined, wherein dynamic objects are not taken into consideration during the orientation.

7. The method according to claim 1, wherein the radar backscatter profiles stored in the high-resolution map are generated by aggregating radar data from a plurality of vehicles.

8. The method according to claim 1, wherein the method is implemented in a driver assistance system that includes at least one of an adaptive cruise control system, or an automatic emergency braking system.

9. A device, comprising:
a computing unit configured to process data of a radar sensor in a vehicle using a high-resolution map, the computing unit configured to perform the following steps including:
reading in the high-resolution map, in which backscatter profiles are stored at associated map positions, each of the backscatter profiles indicating which data the radar sensor of the vehicle would be expected to receive when the vehicle passes the associated map position,
determining a current position of the vehicle;
receiving data from the radar sensor,
comparing the received data of the radar sensor with at least one of the stored radar backscatter profiles at a map position in an environment of a current position of the vehicle,
labeling the radar data according to a result of the comparison, and
providing the labeled radar data.

10. A non-transitory machine-readable storage medium on which is stored a computer program for processing data of a radar sensor in a vehicle using a high-resolution map, the computer program, when executed by a computer, causing the computer to perform the following steps comprising:
reading in the high-resolution map, in which backscatter profiles are stored at associated map positions, each of the backscatter profiles indicating which data the radar sensor of the vehicle would be expected to receive when the vehicle passes the associated map position;
determining a current position of the vehicle;
receiving data from the radar sensor;
comparing the received data of the radar sensor with at least one of the stored radar backscatter profiles at a map position in an environment of a current position of the vehicle;
labeling the radar data according to a result of the comparison; and
providing the labeled radar data.
